(19) United States
(12) Patent Application Publication
(10) Pub. No.: US 2025/0246809 A1
(43) Pub. Date: Jul. 31, 2025

(54) ANTENNA SYSTEM FOR PRODUCING MULTIBEAMS IN ELEVATION

(71) Applicant: Galtronics Canada Ltd., Kanata (CA)

(72) Inventors: Sadegh FARZANEH, Kanata (CA); Mohammadmahdi FARAHANI, Kanata (CA); Zhihua YU, Kanata (CA); Jacob van BEEK, Kanata (CA)

(73) Assignee: Galtronics Canada Ltd., Kanata (CA)

(21) Appl. No.: 19/041,420

(22) Filed: Jan. 30, 2025

Related U.S. Application Data
(60) Provisional application No. 63/626,965, filed on Jan. 30, 2024.
(60) Provisional application No. 63/549,896, filed on Feb. 5, 2024.

(51) Int. Cl. H01Q 3/36; H01Q 1/24

(52) U.S. Cl. CPC H01Q 3/36; H01Q 1/246

(57) ABSTRACT

Systems and methods relating to antenna systems the produce multiple beams that are arrayed in elevation. The antenna system includes multibeam forming network (MBFN) circuitry that receives input signals, and which produces, by way of an antenna array, multiple beams that are vertically adjacent to one another. The MBFN circuitry may comprise a Butler matrix, a Rotman lens, a Blass matrix, a Nolen matrix, or adjusted/modified versions of these matrices. The modified versions of these matrices are designed to address beam squint issues, phase error issues, and even side lobe levels (SLL) issues.

### CROSS-REFERENCE TO RELATED APPLICATIONS

This application claims the benefit of U.S. provisional application No. 63/626,965 filed on Jan. 30, 2024 and U.S. Provisional Application No. 63/549,896 filed on Feb. 5, 2024, which is/are incorporated by reference as if fully set forth.

### TECHNICAL FIELD

The present invention relates to multibeam antenna installations. More specifically, the present invention relates to antenna systems that produce multiple beams for vertical sector splitting and that produce two-dimensional multibeams in azimuth and elevation.

### BACKGROUND

To increase the communication capacity of base stations, multi-beam base station antenna arrays are required to divide the coverage of the base station from an entire area into several smaller cells. As well, it is expected to keep each beam's coverage to be the same within the whole operating frequency band. This beam coverage can become an issue especially with multi-beam antenna arrays.

Even when splitting the base station coverage into smaller cells, this method can still have some issues such as insufficient or less than desirable coverage at the cell edges. As well, for a given base station antenna array, increasing capacity would be advantageous. Preferably, such a capacity increase would not require larger antenna arrays or any extra hardware.

When multibeam is created in azimuth for low band (617-960 MHz), similar to mid-band (1695-2690 MHz), and/or C band (3300-4200 MHz), antenna size will increase. This will increase the wind load and antenna weight for the system, and this is a major challenge for the widespread use of multibeam antennas.

From the above, there is therefore a need for innovations that addresses the cell edge issue while increasing capacity without increasing hardware requirements.

### SUMMARY

The present invention provides systems and methods relating to antenna systems that produce multiple beams that are in elevation. The antenna system includes MBFN circuitry that receives input signals, and which produces, by way of an antenna array, multiple beams that are vertically adjacent to one another. The MBFN circuitry may comprise a Butler matrix, a Rotman lens, a Blass matrix, a Nolen matrix, or adjusted/modified versions of these matrices. The modified versions of these matrices are designed to address beam squint issues, phase error issues, and even side lobe levels (SLL) issues.

In a first aspect, the present invention provides an antenna system comprising:
multibeam forming network circuitry for receiving at least one input signal
an antenna array comprising at least two antenna elements, said antenna array receiving an output of said circuitry
wherein
said system produces at least two output beams from said array such that said at least two output beams are vertically adjacent each other.

In another aspect, the multibeam forming network circuitry comprises a Butler matrix, a Nolen matrix, or a Blass matrix. In a further aspect, the multibeam forming network circuitry comprises a modified version of one of these matrices.

In a further aspect, the present invention provides a matrix circuit for coupling a plurality of input signal beams to a plurality of output antennas, the matrix circuit comprising:
a matrix of directional couplers, horizontal phase delay lines, and vertical circuit element lines;
wherein said matrix is configured to form
a plurality of rows of circuit elements, each row of circuit elements comprising directional couplers and horizontal phase delay lines, each row receiving an input signal beam and each row comprising directional couplers being coupled to at least one other directional coupler by a horizontal delay line; and
a plurality of columns of circuit elements, each column of circuit elements comprising directional couplers and vertical circuit element lines, each column of circuit elements being coupled between an output antenna and a load;
wherein
said matrix circuit is for forming multiple output beams based on said input signal beams; and
at least one of said multiple output beams has a beamwidth that is different from a beamwidth of at least one other of said multiple output beams.

In a further aspect, there is provided an antenna system comprising:
multibeam forming network circuitry for receiving at least one input signal;
an antenna array comprising at least two antenna elements, said antenna array receiving an output of said circuitry;
wherein
said system produces at least two output beams from said array such that said at least two output beams are vertically adjacent each other.

The multibeam forming network circuitry may comprise one or more of: a Butler matrix; a Nolen matrix; a Blass matrix; a modified Blass matrix; a modified Nolen matrix; and a modified Butler matrix.

In another aspect, the multibeam forming network circuitry comprises a matrix circuit, said matrix circuit comprising a plurality of directional couplers and delay lines, said matrix circuit being coupled between a plurality of loads and said antenna array;
wherein
each row of said matrix circuit comprises a plurality of directional couplers coupled in series row-wise, with each row-wise pair of directional couplers being joined by at least one delay line,
each column of said matrix circuit comprises a plurality of directional couplers coupled in series column-wise,
a bottom row of said matrix circuit is coupled to a plurality of matching loads such that each directional coupler of said bottom row is coupled column-wise between a matching load of said plurality of matching loads and a directional coupler of an immediately preceding row of said matrix circuit,
said each row of said matrix circuit provides a distinct signal beam having a unique elevation within a predetermined azimuth range, such that at least three distinct signal beams are provided by said antenna array, said at least three distinct signal beams comprising at least one negative-extreme-azimuth beam corresponding to a negative extreme of said azimuth range, a center azimuth beam corresponding to a center of said azimuth range, and a positive-extreme-azimuth beam corresponding to a positive extreme of said azimuth range, and
said circuit is used to implement a method comprising providing said center azimuth beam with said bottom row of said matrix circuit.

A further aspect of the present invention provides that the multibeam forming network circuitry comprises a matrix circuit, said matrix circuit comprising a plurality of directional couplers and delay lines, said matrix circuit being coupled between a plurality of loads and said antenna array;
wherein
each row of said matrix circuit comprises a plurality of directional couplers coupled in series row-wise, with each row-wise pair of directional couplers being joined by at least one delay line,
each column of said matrix circuit comprises a plurality of directional couplers coupled in series column-wise,
a bottom row of said matrix circuit is coupled to a plurality of matching loads such that each directional coupler of said bottom row is coupled column-wise between a matching load of said plurality of matching loads and a directional coupler of an immediately preceding row of said matrix circuit,
said each row of said matrix circuit provides a distinct signal beam having a unique azimuth within a predetermined elevation range, such that at least three distinct signal beams are provided by said antenna array, said at least three distinct signal beams comprising at least one negative-extreme-elevation beam corresponding to a negative extreme of said elevation range, a center elevation beam corresponding to a center of said elevation range, and a positive-extreme-elevation beam corresponding to a positive extreme of said elevation range, and
said circuit is used to implement a method comprising providing said center elevation beam with said bottom row of said matrix circuit.

In various implementations, phase compensation is applied to each of said plurality of directional couplers.

In a further aspect, the multibeam forming network circuitry comprises a matrix circuit, said matrix circuit being for coupling a plurality of input signal beams to said antenna array, said matrix circuit comprising:
a matrix of directional couplers, horizontal phase delay lines, and vertical circuit element lines;
wherein said matrix is configured to form
a plurality of rows of circuit elements, each row of circuit elements comprising directional couplers and horizontal circuit element, each row receiving an input signal beam and each row comprising directional couplers being coupled to at least one other directional coupler by a horizontal delay line; and
a plurality of columns of circuit elements, each column of circuit elements comprising directional couplers and vertical circuit element lines, each column of circuit elements being coupled between an output antenna in said antenna array and a load;
wherein said matrix circuit is for forming multiple output beams based on said input signal beams.

As another aspect of the present invention, the input signal beam having a lowest absolute value elevation angle of said plurality of input signal beams is received by a specific row of said matrix circuit, said specific row being most adjacent to loads to which said matrix circuit is coupled.

According to yet another aspect of the present invention, the input signal beam having a lowest absolute value azimuth angle of said plurality of input signal beams is received by a specific row of said matrix circuit, said specific row being most adjacent to loads to which said matrix circuit is coupled.

Yet a further aspect of the present invention provides that the vertical circuit element lines are implemented as one or more of: phase shifters; adjustable/variable phase shifters; and vertical phase delay lines. Similarly, the horizontal circuit element lines are implemented as one or more of: phase shifters; horizontal phase delay lines; and adjustable phase shifters.

Each of said at least two antenna elements in said antenna array may be coupled to said circuitry by way of a phase shifter. As well, in a further aspect, the system further produces at least one further output beam, said at least one further output beam being horizontally adjacent to at least one of said output beams.

Of the at least two output beams, at least one of said at least two output beams has a beamwidth that is different from a beamwidth of another of said least two output beams.

For some aspects, each of said adjustable phase shifters has an electromechanically adjustable phase shift, at least one of said adjustable phase shifters comprising:
a first trace for coupling to a first port;
a second trace for coupling to a second port;
a bridge element that couples said first trace to said second trace;
wherein
said bridge element overlays atop both said first trace and said second trace such
that said bridge element provides an electrical path for signals traveling between said first port and said second port;
said bridge element is mechanically movable between at least two positions;
moving said bridge element from one position to another position of said at least two positions changes a length of said electrical path between said first port and said second port.

For another aspect, the at least two positions comprises any one of:
a first fixed position and a second fixed position;
a plurality of fixed positions;
wherein each fixed position is a fixed setting for a specific length of electrical path
between said first port and said second port.

For the various aspects of the present invention, the antenna system has a performance that is equivalent to a performance of another antenna system that has a larger antenna array in size. Furthermore, in some aspects, the antenna system has a performance that is equivalent to a performance of another antenna system that has a larger number of antenna columns than said antenna system. As well, in some aspects, the at least two output beams provide pattern diversity to improve a wireless link implemented through said antenna system.

For some implementations, at least one input signal beam is coupled to produce at least one output beam using all of said antennas in said antenna array. In some other implementations, at least one input signal beam is coupled to produce at least one output beam using a subset of said antennas in said antenna array.

### BRIEF DESCRIPTION OF THE DRAWINGS

The embodiments of the present invention will now be described by reference to the following figures, in which identical reference numerals in different figures indicate identical elements and in which:

FIG. 1 is a diagram illustrating an antenna system producing two beams that are vertically adjacent one another (i.e., in elevation);

FIG. 2 is a block diagram of an antenna system according to one aspect of the present invention;

FIGS. 3-7 illustrate antenna arrays that may be used with the various aspects of the present invention;

FIG. 8 illustrates a Blass matrix which may be used as the MBFN for use with the present invention;

FIG. 9 is a schematic diagram of a modified Nolen matrix with arbitrary number of radiating elements and beams which may be used with the present invention;

FIG. 10 is a schematic diagram of a modified Nolen matrix that has been modified to compensate for phase errors;

FIG. 11 is a schematic diagram of another modified Nolen matrix that has been modified to compensate for phase errors using a different method than was used in FIG. 10;

FIG. 12 is a schematic diagram of another modified Blass matrix that creates different beams with different beam widths;

FIG. 13 illustrates an example of three beams being produced with two beams having one beamwidth and one beam having a narrower beamwidth;

FIG. 14 and FIG. 16 show conventional multi-port antennas;

FIG. 15 and FIG. 17 show equivalently capable antennas to those in FIGS. 14 and 16 but which are significantly smaller in physical size;

FIG. 18 shows a 4-port antenna array for nominal 45 degree azimuth beamwidth;

FIG. 19 shows a 4-port antenna array of equivalent capability to the antenna in FIG. 18 but with a much narrower configuration;

FIG. 20A is a schematic diagram of a matrix circuit in which the top row has variable phase shifters;

FIG. 20B is a schematic diagram of a matrix circuit in which all rows have variable phase shifters;

FIG. 21A is a schematic diagram of a trombone-shaped phase shifter;

FIG. 21B is a schematic diagram of a variable phase shifter that uses rotary motion to adjust the phase delay;

FIG. 21C is a schematic diagram of another structure for a variable phase shifter that also uses rotary motion to adjust the phase delay;

FIG. 21D is a schematic diagram of a structure for a variable phase shifter that uses a linear motion of a high-permittivity dielectric slab to adjust the phase delay;

FIG. 21E illustrates a trombone-shaped phase shifter integrated with the couplers;

FIG. 21F is a schematic diagram for explaining the function and mechanism for the structure illustrated in FIG. 21E;

FIG. 21G further is a schematic diagram for explaining the function and mechanism for the structure shown in FIG. 21D;

FIG. 21H illustrates another structure for a variable phase shifter that uses rotary motion;

FIG. 22 illustrates a 12-port antenna array embodying multiple aspects of the present invention;

FIG. 23 illustrates a 16-port antenna array that may be used with the various aspects of the present invention;

FIG. 24 is a schematic diagram of a low-band matrix circuit according to multiple aspects of the present invention;

FIGS. 25-28 show four circuit boards that are different implementations of the matrix circuit illustrated in FIG. 24;

FIG. 29 illustrates an example of two beams produced by the low-band array shown in FIG. 22 or in FIG. 23;

FIG. 30 illustrates a 12-port antenna array embodying multiple aspects of the present invention;

FIG. 31 illustrates a schematic diagram of a mid-band matrix circuit that uses multiple aspects of the present invention;

FIG. 32 illustrates an example of two beams being produced with the mid-band array shown in FIG. 31;

FIG. 33 illustrates an example of an antenna array for low-band elevation beamsplitting that may be used with similar performance as the antenna arrays (with a 45-degree azimuth beamwidth) shown in FIG. 22 and FIG. 23.

### DETAILED DESCRIPTION

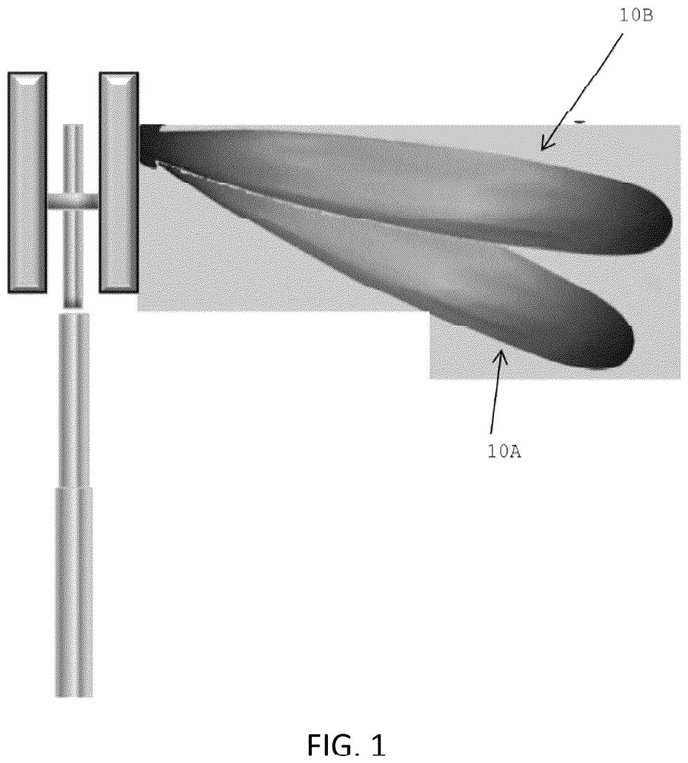

In one aspect of the present invention, there is provided an antenna system producing multiple beams such that the multiple beams are vertically adjacent to one another. That is, the multiple beams are such that they split the cell into multiple cells in elevation as opposed to splitting the cell into multiple cells in azimuth. In its simplest form, FIG. 1 shows two beams from a single antenna array with beam 10A (the bottom beam) being a low band beam and covering the area close to the antenna tower and with beam 20A (the top beam) being a high gain low band beam that provides coverage to the edge of the cell.

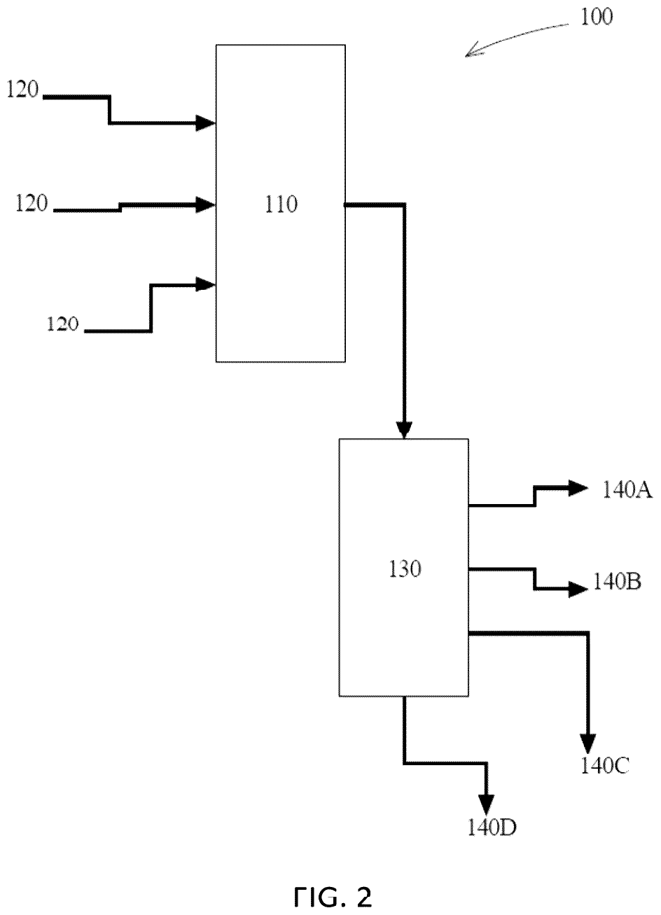

Referring to FIG. 2, a block diagram of an antenna system according to another aspect of the present invention is illustrated. As can be seen, the antenna system 100 includes a multibeam forming network (MBFN) 110 that receives one or more input signals 120. The output of the MBFN is received by an antenna array 130 and the antenna array produces multiple beams 140A, 140B, 140C, 140D that are vertically adjacent one another. Or, in other words, the multiple beams in elevation are generated such that the resulting beams are vertically adjacent each other.

For clarity, the present invention also includes generating, in addition to the multibeams in elevation, other multibeams in azimuth. That is, in addition to the multiple beams that are adjacent one another vertically (or in elevation), other beams are also generated such that these beams are adjacent each other horizontally or in azimuth.

In terms of frequency bands, the multibeams that are generated in elevation can be of low band, mid-band, C-band, or high band frequencies or can be any mix of these frequencies. Similarly, in implementations that mix the multibeams generated in elevation with multibeams generated in azimuth, any of the beams (whether in elevation or in azimuth) may be of low band, mid-band, C-band, or high band. For such a mix of elevation and azimuth multibeams, in one implementation, the elevation multibeam can be of any of the bands noted above and can be in elevation at any preferred angle while the rest can be standard multibeams in azimuth at 65 degrees, 80 degrees, or 90-degree azimuth.

For even greater clarity, references to low band, mid-band, C-band, and high band frequencies in this document are to be taken to mean the following frequency ranges:
Low band: 617-960 MHZ
Mid-band: 1695-2690 MHz
C-band: 3300-4200 MHZ
High band: 24 GHz-40 GHZ

As well, the various aspects of the present invention may also be used in conjunction with cellular applications that involve frequencies such as 600 MHz to 2.5GHz, 450 MHz to 6GHz, and 24 GHz to 52 GHz.

Well-known configurations and technologies relating to antennas and antenna arrays may be used with the present invention. As an example, 4T4R may be used per beam or 8T8R radios may be used for each couple of beams. The multibeams generated in elevation could be fixed beams or these beams may be adjusted/moved using manual electrical tilt (MET) methods and devices or the adjustment/movement may be accomplished using remote electrical tilt (RET) methods and subsystems.

This concept of using multibeam in elevation can be extended such that multiple beams can be generated not just in azimuth or in elevation but at any angle that combines both azimuth and elevation. As an example, instead of merely producing beams that are at +35 and −35 degrees in azimuth but at zero degrees elevation or beams that are zero degrees azimuth but at +35 and −35 degrees in elevation, a beam that is at +35 degrees elevation, +35 degrees azimuth and a beam at −35 degrees elevation, +35 degrees azimuth can be generated. Similarly, a beam that is at +35 degrees elevation, −35 degrees azimuth and a beam at −35 degrees elevation, −35 degrees azimuth can be generated.

It should also be clear that the use of the present invention can reduce antenna aperture size. Additionally, the use of the present invention can reduce the wind load and the antenna weight for the antenna array. In particular, when low band multibeams in azimuth are generated with an antenna array, the antenna size increases drastically. By generating low band multibeams in elevation and midband and C band multibeams in azimuth, this significantly reduces antenna size. By reducing antenna size, this also significantly reduces antenna weight and wind load. In fact, by implementing the advances detailed above, a large multibeam antenna array is reduced to an array that has the same size of standard macro antennas. This advance allows for the widespread use of multibeam antennas for macro applications.

Conventional base station antennas or macro antennas are usually deployed as MIMO systems to mitigate channel fading and increase channel capacity and throughput. Designing such an antenna system as a MIMO system involves implementing parallel clusters of arrays corresponding to different ports. Our present invention provides the same number of ports as a conventional MIMO system of base station antennas; however, it requires only half the number of clusters.

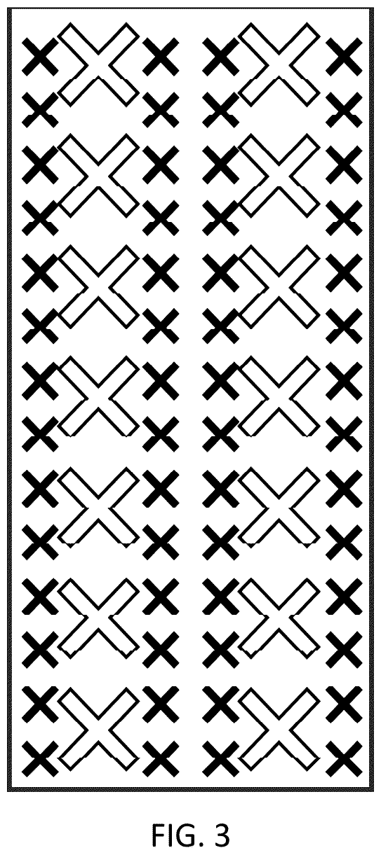

In terms of implementation of the antenna array, FIGS. 3-7 illustrate examples of antenna arrays which may be used to implement the various aspects of the present invention.

In FIG. 3, illustrated is a 12-port macro antenna with 4-port low-band and 8-port mid-band and which has been converted into a 16-port or 20-port antenna with 8-port mid-band and 8 or 12 ports low band. The original antenna was an array that produced multibeams in 65-degree azimuth in both low band and mid band frequencies. In the modified antenna, low band is 65 degrees in azimuth but in elevation has 2 or 3 beams depending on application. In this way, a low band antenna array can offer two or three beams in elevation. It should be noted that the converted antenna array has smaller dimensions than the original (i.e., the converted antenna array is narrower) and this reduction in dimensions lowers antenna array weight and lessens wind loading.

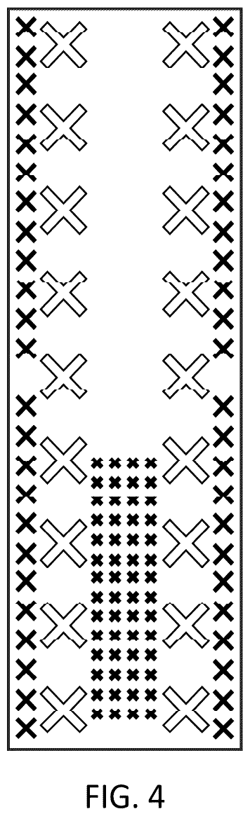

In FIG. 4, illustrated is a 20-port macro antenna with 4-port low-band and 8-port mid-band and 8-port C band. In the original antenna, low band and mid-band frequency beams were produced with standard 65-degree azimuth antennas. As well, for the original antenna, C band was 8T8R beamforming. The modified antenna has 24-ports or 28-ports with 8-port mid-band, 8 port C-band, and 8 or 12 ports low band. The low band beamwidth is 65 degrees in azimuth but in elevation has 2 or 3 beams depending on application. The modified antenna has the same footprint as a standard macro antenna but offers multiple low band beams in elevation to address the cell edge coverage issue by dividing the low band sector into 2 or 3 sectors.

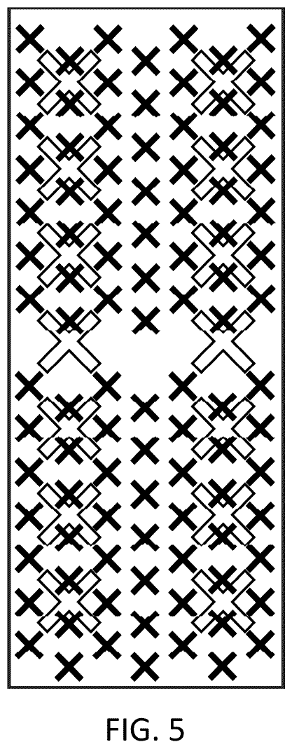

In FIG. 5, illustrated is another example of an antenna array that may be used with the present invention. In this example, the antenna array is a midband array with 3 beams in azimuth and which also produces 2 or 3 low band beams in elevation. Each beam has 4-ports for 4×4 MIMO. In total, this example has 12-port mid-band and 8 or 12-ports low band beams depending on whether the low band frequencies have 2-beams or 3-beams. This antenna offers low band and mid-band multibeam in a macro antenna footprint. If low band multibeam was in azimuth as well, antenna size width would be much wider, with a corresponding increase in wind load and antenna weight. This is an example that uses a multibeam antenna in a dense macro environment. For this antenna, mid-band frequency capacity is increased by having multiple beams in azimuth. At the same time, low band frequency capacity is boosted by having two or three low band beams in elevation. This antenna may be used in applications such as inside of a stadium where the antenna is mounted in the stadium rafters and with the antenna shooting down.

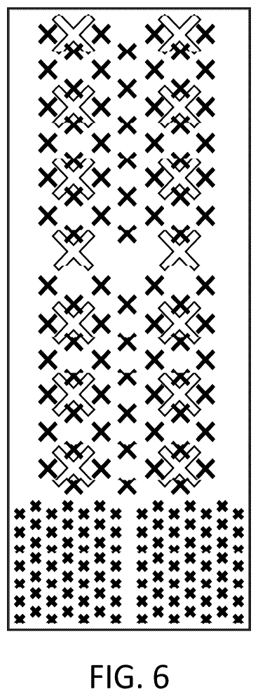

In FIG. 6 is illustrated a similar example as FIG. 5 but which integrates a 3-beam C band in azimuth. In this example, the array has 3 beams in azimuth in mid-band and C band and with 2 or 3 beams in elevation for low band. This is another example of multibeam macro which has C band as well. This antenna offers low band, mid-band, and C band multibeam in a macro antenna footprint. If low band multibeam was in azimuth as well, the resulting antenna size width would be much wider, with a corresponding increase in wind load and weight.

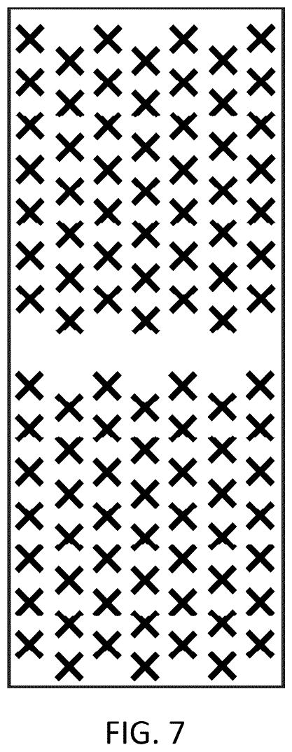

In FIG. 7, illustrated is an antenna array which has been converted from 3-beam in azimuth to 6-beam or 3-beam in elevation. Overall, the antenna array illustrated has 9-beam or 18-beam using the same aperture size. By producing multibeams in both azimuth and elevation, the number of beams is increased while the antenna aperture is in a macro antenna footprint. This antenna array may be used in an application such as in a stadium environment where the antenna is mounted on rafters and is shooting down at the stadium seats. This way multiple spot beams effectively divide the area in two dimensions.

In terms of implementation of the MBFN, the multibeam forming network may use a Butler matrix, a Nolen matrix, a Blass matrix, a VBD (Variable Beam Direction) Blass matrix or adjusted/modified versions of these matrices or a Rotman lens. As noted above, the MBFN for one aspect of the invention produces multiple beams in elevation. One or more other MBFNs may also be present that produces other multiple beams in azimuth, in addition to the multibeams in elevation. These MBFNs that produce multiple beams in azimuth may utilize a different antenna array from the antenna array that produces multiple beams in elevation.

For a Blass matrix implementation of the MBFN, the conventional Blass matrix causes beam squint in the resulting beams. This can be mitigated or even canceled by judicious assignment of different beams to different rows of the Blass matrix circuit. In particular, for a set of beams over a given elevation range, a “center beam” is conventionally provided by a center row of the matrix. In this implementation of the present invention, the center beam is assigned to the lowest row of the Blass matrix. This reduces the fundamental degradation of the higher scan-angle beams that otherwise results from the array aperture at lower rows.

As is well-known, beam squint refers to the phenomenon wherein beam direction scans undesirably but inevitably with frequency changing. As the frequency changes, the beam direction (i.e., the direction of the signal in the elevational direction) will change, although the beam would preferably maintain a constant direction. Due to beam squint, the areas of beam coverage will be different at various frequencies (i.e., the areas of beam coverage will be different for up-link and down-link), meaning that the antenna array is unable to achieve closed-loop communication. This problem is exacerbated as the fractional bandwidth increases, for example, wider than 30% bandwidth.

To effectively cancel the beam squint, note that, in a Blass matrix structure, beam squint results from a combination of two factors:
(1) the phase-shift caused by Blass matrix rows; and
(2) the elevational angle (i.e., direction) of the beams.

In other words, the beams that are at more extreme angles inherently have higher squint. For example, the beam pointing to zero degrees (i.e., without any elevational tilt and is therefore pointing directly at the horizon) has inherently less squint compared to a beam located at +/−30° from horizontal.

It should be noted that the first factor is unavoidable because, as the signal travels from one row to the next, the signal undergoes a phase shift which plays an important role in maintaining the elevational beam angle. But the beam squint resulting from the elevational angle of the beams can be mitigated by assigning the rows of the matrix to provide rows for specific angles.

In particular, the conventional Blass matrix design provides a plurality of beams across a given elevation range (e.g., for a 3-row matrix, the elevation range might be (−30°, 0°, +30°). A beam pointing to an extreme (i.e., the top beam, e.g., +30 in the example range, in which the positive extreme is at the top) is provided by the topmost row of the matrix; the beam pointing to the center of the range (e.g., at 0 degrees or directly at horizontal) is provided by the center row of the matrix; and the beam pointing to the opposite extreme (i.e., the bottom beam, e.g., −30 in the example range, in which the negative extreme is at the bottom of the 3 beams that are vertically adjacent one another) is provided by the bottom row of the matrix. As would be understood, either the positive or the negative extreme can be positioned at the top/bottom of the matrix in a conventional matrix.

However, because of its position on the lowest row, the negative-extreme beam in this conventional design will have the most loss and therefore the lowest gain, and thus a higher phase-shift. As it already has a high beam squint due the extremeness of its angle, as explained above, this low gain and high loss results in further beam squint and lower quality overall.

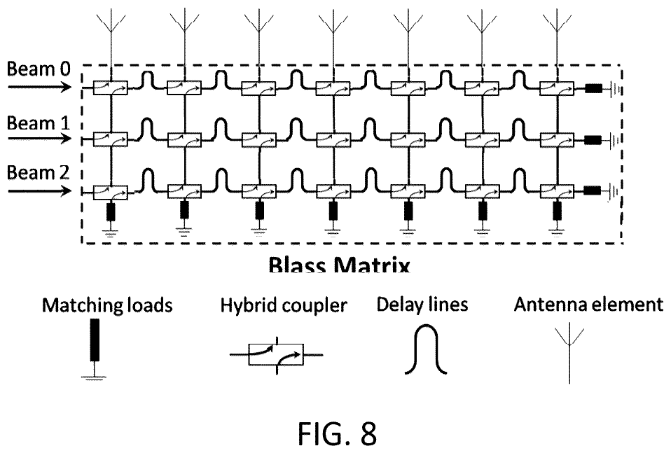

To address this beam squint issue, the center beam is assigned to the lowest row of the Blass matrix, instead of the positive-extreme beam. The center beam, because it inherently has the highest directivity due to pointing to 0 elevation, is less affected by the additional loss resulting from being positioned on the bottom row of the matrix, in comparison to the conventional extreme-elevation beam assigned there. A three beam Blass matrix configuration that may use this beam assignment scheme is shown in FIG. 8.

As would be understood by the person skilled in the art, to observe a benefit from the beam assignment scheme, the Blass matrix should have at least three rows. However, it should be noted that the elevation range is not required to be symmetrical or to be centered at 0 degrees. Further, there is no requirement or preference for matrices with either an odd or an even number of rows. The person skilled in the art would understand how to apply the present disclosures to a particular desired implementation. As one non-limiting example, in an implementation using a matrix with an even number of rows, the bottom two rows of the matrix could correspond to the beam pair with the lowest absolute value and thus highest directivity.

Further, as should be understood, the assignment of beams to the other rows of the matrix may be different in different embodiments. For example, in some embodiments, the extreme-elevation beam is assigned to the center row of the matrix and no other beam assignments differ from the conventional assignment method. In other embodiments, multiple beam assignments differ from the conventional assignment method. For example, in some embodiments, the topmost two rows are assigned to provide the most extreme beams (i.e., the beam with the largest positive elevation and the beam with the largest negative elevation). In some such embodiments, moreover, the absolute value of the beam elevation decreases for each successive pair of rows, until the last row of the matrix. Further, depending on the embodiment, either the top beam (the extreme positive elevation beam) or the bottom beam (the extreme negative elevation beam) may be assigned to the center row.

Further, in some embodiments, phase compensation is applied in addition to implementing the beam assignment method. This phase compensation involves mitigating the phase error introduced by each of the plurality of couplers. Ideally, the phase of each coupler is 90 degrees. However, when the coupling coefficient becomes larger than −3 dB, the coupler phase varies depending on the coupler coefficient. Therefore, phase compensation for each coupler is, in some embodiments, applied so that the phase of all the couplers becomes similar. This can be achieved by adding an extra phase factor on both the horizontal and the vertical lines that connect a coupler from one row to another row.

Based on the above, for a Blass matrix implementation of an MBFN for elevational tilt multibeams, a plurality of signal beams is first provided to a Blass matrix circuit. The center beam (i.e., the one of the pluralities of signal beams that has the least absolute elevational tilt) is assigned to the bottom row of the Blass matrix circuit. This mitigates beam squint and helps to balance gain between the beams, as detailed above.

To mitigate for phase errors, a plurality of signal beams are provided to a Blass matrix circuit. Phase compensation is then applied to the directional couplers in the matrix circuit. The center beam is then assigned to the bottom row of the Blass matrix circuit. It should be clear that the phase compensation may be applied before or after the beam assignments in the Blass matrix circuit.

For a Nolen matrix implementation of the MBFN to thereby produce multibeams with elevational tilt, a revised Nolen matrix can be used to address phase errors and beam squint.

For a Nolen matrix implementation of the MBFN, to compensate for phase errors, phase shifters or transmission line delay lines are used between rows of the Nolen matrix. Alternatively, cascaded phase shifters may be used in-between the rows. To compensate for beam squint, as with the Blass matrix explained above, the input signal beam with the least elevation angle is assigned to the Nolen matrix row that is most adjacent to the loads (i.e., the bottom most row). To accomplish the above, the phase error is calculated and then the desired phase shift to compensate for the phase error is determined. The desired phase shift is then implemented using the phase shifters/delay lines/cascaded phase shifters.

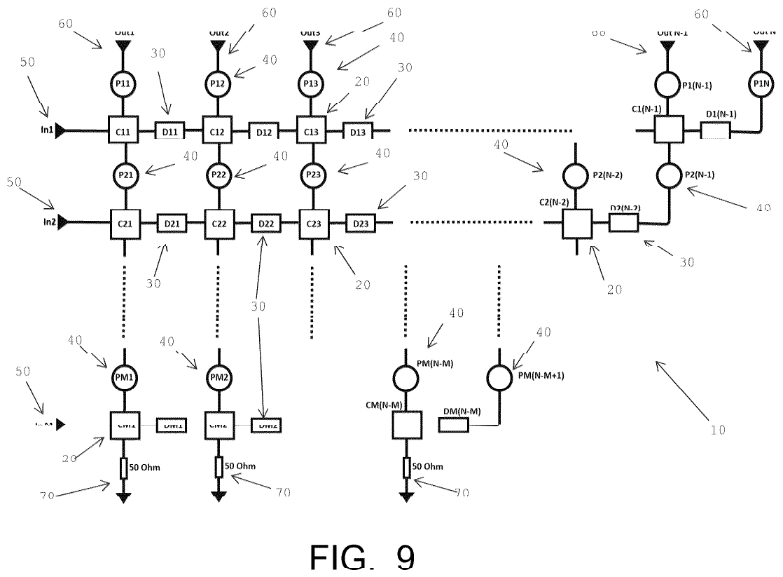

Referring to FIG. 9, a schematic diagram of a conventional Nolen matrix is illustrated. As is known, a conventional Nolen matrix consists of different components such as directional couplers, phase delay lines and so on. The Nolen matrix in FIG. 9 has M inputs (input signal beams) and N outputs (antenna outputs/antenna elements).

As can be seen in FIG. 9, the Nolen matrix 10 has a number of columns and rows with couplers 20, horizontal phase delay lines 30, and vertical circuit element lines 40. The Nolen matrix couples the input signal beams 50 to the output antenna elements 60 through the various couplers, phase delay lines, and circuit element lines. It should be clear that each column of the Nolen matrix has a collection of couplers and circuit element lines between an output antenna element and a load 70. It should also be clear that the lowest row of the Nolen matrix is the row 80 that is most adjacent the loads 70 while the highest row of the Nolen matrix is the row 90 that is most adjacent to the output antenna elements 60.

For greater clarity, in FIG. 9, the couplers are shown in squares denoted with a “Cxx”, the horizontal phase delay lines are shown in rectangles denoted with a “Dxx”, and the vertical circuit element lines are shown in circles denoted with a “Pxx”. The coupling factors and phase delay lines are calculated using software. It should be noted that, in a conventional Nolen matrix, there are some phase errors which degrades the performance of the matrix.

One solution to fixing the phase error problem is to determine the phase error for a particular antenna element and then to compensate for this phase error by using engineered/designed vertical circuit element lines between the various rows (for one specific column). The various vertical circuit element lines between the rows would introduce phase shifts that compensate for the phase error. As an example, from FIG. 9, the phase error for antenna element Out2 can be determined and the vertical circuit element lines P12, P22. . . . PM2 can be engineered/designed to compensate for this phase error for antenna element Out2.

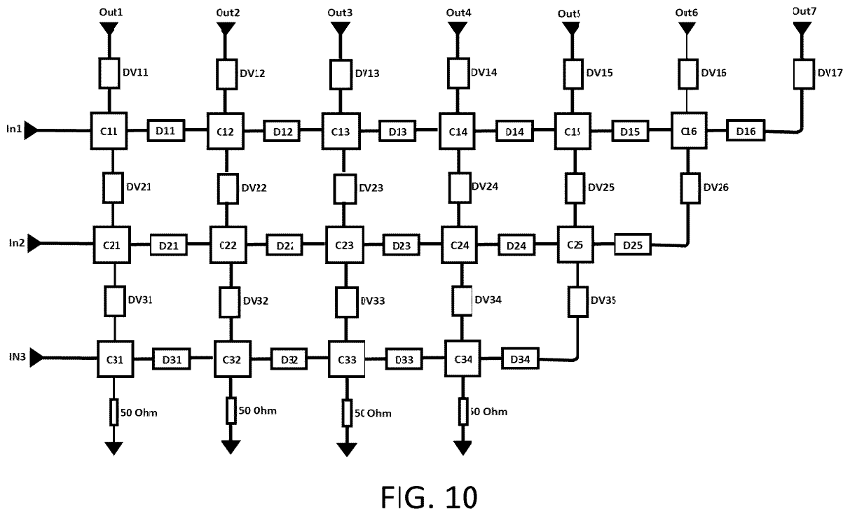

In one aspect of the present invention, only transmission lines are used between the output of a coupler in one row to the input of a coupler in the next row. The lengths of transmission lines are optimized in a way to create desired different phases, to compensate for the phase errors that occur at the input of the antenna elements (i.e., the output of the Nolen matrix). A sample 3-beam input, 7-elements output structure was designed using this innovation and this is illustrated in FIG. 10. This structure, properly implemented, outputs multiple beams that are elevationally or vertically adjacent one another.

As shown in the figures, the phase and amplitude of the beam is optimized and adjusted so that performance improves in terms of both beam squint and SLL. As this method provides more degrees of freedom (by adding different and optimized vertical transmission lines), the new Nolen matrix (shown in FIG. 10) operates in a wide range of frequencies 1695-2690 MHz (wideband). This configuration of a new Nolen matrix also operates in other frequencies as well, including low band, mid-band, and even C-band.

As another option, the order of the input signal beams assigned to the rows in the matrix can also be adjusted for the configuration in FIG. 10. For a conventional three elevational beam configuration (with beams pointing at +30 above horizontal, 0 degrees (i.e., at horizontal), and pointing at −30 degrees below horizontal), the conventional wisdom is to place the highest elevation angle beam at the top row, i.e. +30 degrees, 0 degrees, −30 degrees, such that the zero elevation angle beam (i.e. pointing at horizontal) is in the middle row while the −30 elevation angle (i.e. pointing at 30 degrees below horizontal) input beam is at the bottom row. For this aspect of the invention, the order maybe that of: −30, 0, +30. Thus, the zero-elevation angle beam is still in the middle row while the −30 degree elevation angle beam is at the top row while the +30 elevation angle beam is at the bottom row. This novel configuration can reduce overall phase error.

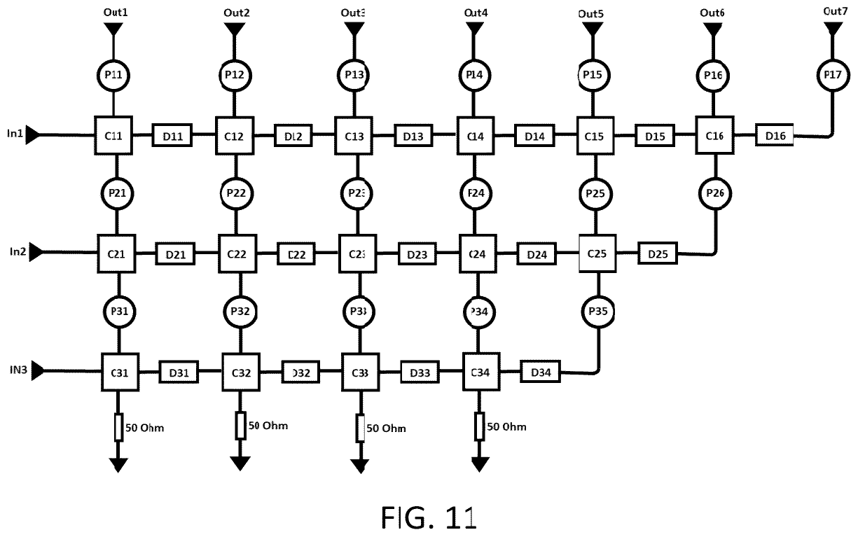

Another solution to the issue of beam squint and SLL is to use phase shifters instead of vertical phase delay lines between any two rows. For this innovation, a 3-beam input, 7-element output Nolen matrix configuration was designed and the block diagram for this configuration is presented in FIG. 11. As an example, as can be seen in FIG. 11, phase shifter P22 is between coupler C12 (in the top row) and coupler C22 (in the middle row). In FIG. 10, instead of phase shifter P22, a vertical delay line DV22 is used between these same couplers.

As a variant to the above, instead of using a single-phase shifter between adjacent rows, several cascaded phase shifters are used between adjacent rows (i.e., instead of the circular “Pmn” blocks in FIG. 11, there would be two or more phase shifters between per pair of rows) in order to compensate for the phase error of the network. As an example, instead of phase shifter P22 between coupler C12 and coupler C22 in FIG. 11, two or more cascaded phase shifters would be used between these couplers. Similar to the above innovation, by adding the cascaded phase shifters, the beam squint cancels, and the SLL improves compared to the conventional Nolen matrix.

Compared to the conventional Nolen matrix, the innovations detailed above for a modified Nolen matrix implementation of an MBFN does not produce any beam squint, the SLL is improved, and the modified Nolen matrix works in a wider frequency band, covering the whole mid-band frequency range. It should also be noted that the innovations detailed above work for mid-band frequencies (1695-2690 MHz) and for other frequencies such as low band, C-band, etc.

Referring to the circuits in FIG. 10 and FIG. 11, these designs produced two different Nolen matrices with two different approaches. The designs each have 3 inputs which give 3 beams with different elevational directions. The resulting matrices have 7 outputs which are connected to 7 antenna array elements. The coupler values and horizontal delay line phase numbers are obtained using theoretical methods using appropriate software. Essentially, the phase errors to be compensated for are measured/calculated and the compensating phase shift is designed into the relevant delay line and/or phase shifter/cascaded phase shifter. As noted above, the vertical phase delay lines and phase shifters are optimally designed in such a way that they compensate for the phase error.

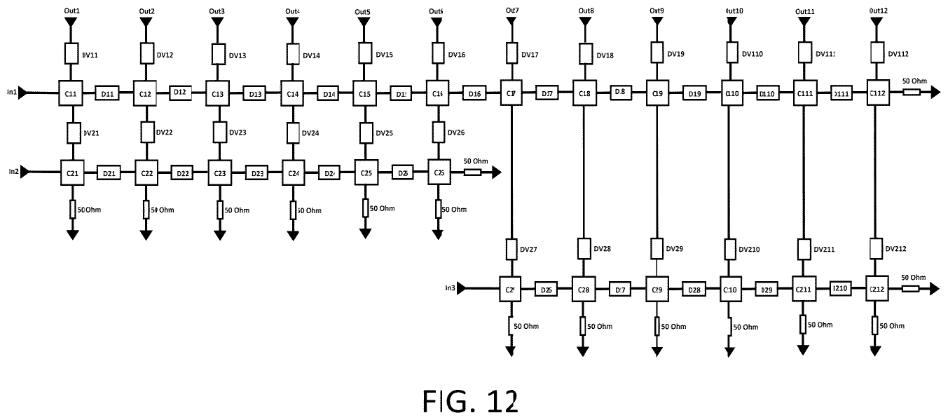

FIG. 12 shows another configuration of circuit elements which may be used to create multiple beams in azimuth and elevation when it is desired to produce beams with different beam widths. As can be seen from FIG. 12, three inputs produce three beams, with one beam using the whole array while the other two beams only use half of the array. As can be seen in FIG. 12, different beams have different numbers of couplers and phase shifters/vertical delay lines.

As can also be seen from FIG. 12, the configuration of circuit elements forms a matrix of directional couplers, horizontal phase delay lines, and vertical circuit element lines. The matrix is composed of multiple rows of circuit elements, each row of circuit elements having directional couplers and horizontal phase delay lines, with each row receiving an input signal beam. As well, each row includes directional couplers that are coupled to at least one other directional coupler in the same row by a horizontal delay line. The matrix is also composed of a number of columns of circuit elements, with each column of circuit elements having directional couplers and vertical circuit element lines. Each column of circuit elements is coupled between an output antenna and a load.

Referring to FIG. 13, illustrated is an example of three beams being generated where the first beam is narrower that the other two beams. The wider beams can cover the area closer to the antenna tower, while the narrower beam can cover the area at the cell edge. It should be clear that the configuration illustrated in FIG. 12 can be used to generate the three beams shown in FIG. 13. For such an implementation, the narrow beam is produced by the input that uses the whole array while the two broader beams are produced by the two inputs that use only half of the array.

It should be noted that, while the structure in FIG. 12 is configured for 3 beams, the general concept allows for any number of beams and antenna array sizes. As well, it should be clear that different beams can have different beamwidths as desired such that any number of beams (whether in elevation or in azimuth) can be generated with any of the beams having different beamwidths. For clarity, while the configuration in FIG. 12 is based on a Blass matrix, a similar configuration based on a Nolen matrix can also be used.

The various aspects of the present invention may also be used in antenna systems that are significantly smaller in physical size than antenna systems with equal capabilities. For this aspect of the present invention, multibeams in elevation are used for pattern diversity to produce antenna arrays that are significantly physically smaller than equally capable arrays.

As is well-known, most base stations use diversity to improve signal quality by exploiting multipaths. Diversity could be polarization diversity, spatial diversity or pattern diversity. Most base station antennas use polarization diversity and spatial diversity. In a 4×4 MIMO base antenna there are two dual-polarization columns that are spaced apart to offer polarization diversity and spatial diversity. For clarity, to obtain spatial diversity gain, two antenna arrays should be placed significantly apart from each other (with the distance between the arrays depending on the angle spread of receive signals) to exploit spatial diversity. This needs to place arrays apart from one another conflicts with the desire to reduce the antenna footprint. Reducing the antenna's physical footprint or size reduces the effect of wind load on the antenna. As an example, in a 12-port antenna array which has 4-port low band elements and 8-port mid-band elements, it is desirable to keep the overall antenna width under 20″.Reducing the antenna width to reduce wind load causes the distance between the two columns of low band elements to be close to half wavelength. Also, when there are 4 columns of mid-band elements, array spacing is also about half wavelength. For many impinging angle spreads, a spacing of about half a wavelength does not offer very good spatial diversity.

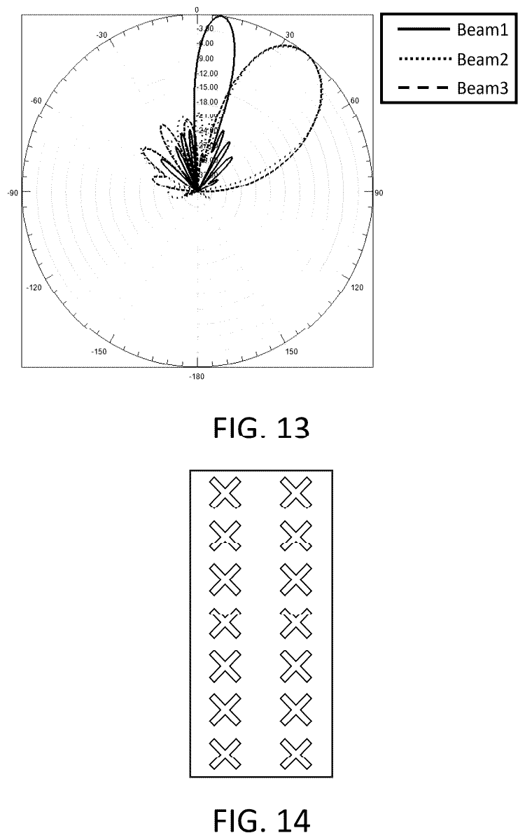

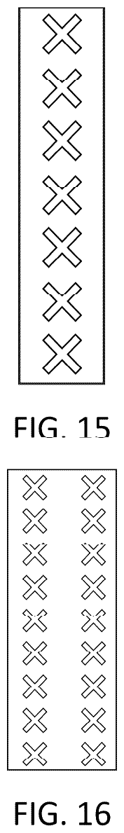

The aspect of the present invention that relates to elevation multibeams can be used to provide pattern diversity and, by also using polarization diversity, 4×4 or 8×8 MIMO antenna arrays can be produced that are physically smaller in size than equally capable arrays. In the resulting antenna arrays, each array column is fed with a multibeam network that produces at least two beams in elevation (i.e., at least two beams that are vertically adjacent or are atop one another). As noted above, the resulting antenna arrays are physically smaller than similar antenna arrays. In one example, a conventional 4-port low band antenna array has an antenna width of about 20-25″. An equivalent array that uses the multibeam in elevation only has an antenna width of about 10-15″. Such a reduction in size reduces the antenna wind load and antenna weight by about half. Similarly, the reduction in size also reduces the overall cost of the antenna. FIG. 14 shows a conventional 4×4 MIMO with polarization and spatial diversity. FIG. 15 shows a 4×4 MIMO with polarization diversity and pattern diversity with the antenna using dual beams in elevation according to one aspect of the present invention. As noted above, the antennas in FIG. 14 and FIG. 15 have similar or comparable capabilities with the antenna in FIG. 15 being physically smaller (i.e., narrower) than the antenna in FIG. 14 (assuming that the antenna elements for both antennas are of a uniform size).

It should be clear that the antenna array using multibeam in elevation can use vertical beam splitting for pattern diversity. This provides distinct paths for multipaths between two beams. Thus, when users are at the cell edge, their devices can communicate through the higher beam (e.g., beam 10B in FIG. 1). This allows for cell edge coverage to be improved. Similarly, when users are close to the antenna tower, their devices communicate through the lower beam (e.g., beam 10A in FIG. 1). There can be multiple paths for signals from the same user in both beams. In this case, the radio will use diversity combining to optimize the signal quality.

It should be clear that the use of multibeams in elevation with vertical beam splitting for pattern diversity and the use of polarization diversity and pattern diversity with multibeams in elevation can be applied to different base stations and small cell antennas. Such antennas and antenna arrays can be single band or multiband as desired. Examples of the application of these concepts to different antennas are provided by way of FIG. 16 to FIG. 19.

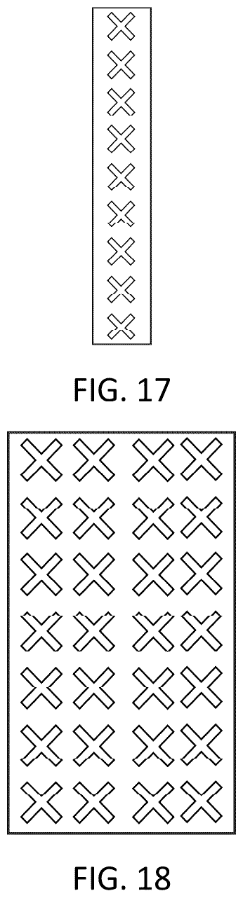

Referring to FIG. 16, illustrated is a 65-150-degree azimuth beamwidth antenna with the typical two columns of dual polarized antenna elements to provide a 4×4 MIMO. FIG. 17 shows a 4-port antenna that provides an equivalent 4×4 MIMO that uses the vertical beam splitting concept of the present invention. As can be seen, the antenna in FIG. 17 only has a single dual polarization column of antenna elements.

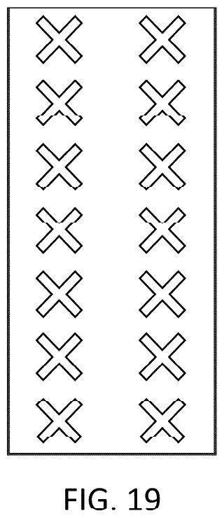

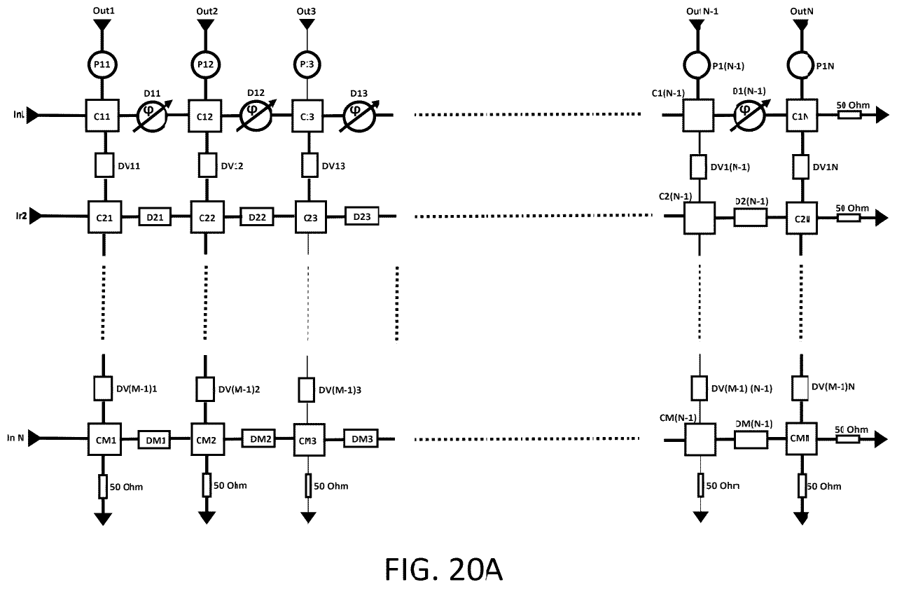

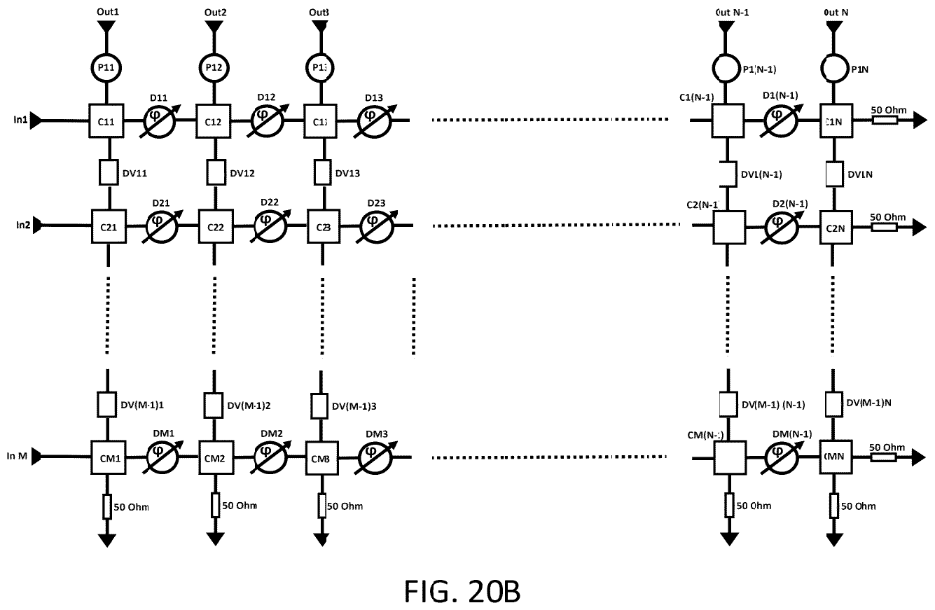

Referring to FIG. 18, illustrated is a nominal 45-degree azimuth beamwidth antenna that has the typical 4 columns of dual polarized antenna elements. FIG. 19 shows an equivalent 4-port antenna that uses the above-noted vertical beam splitting concept of the present invention. As can be seen, the antenna in FIG. 19 only has 2 columns of dual polarized antenna elements and, accordingly, is much narrower than the antenna in FIG. 18.

As another example, a nominal 33-degree azimuth beamwidth antenna typically has 6 dual-polarization columns for a 4×4 MIMO. Applying the multibeam in elevation, an equivalent antenna would only have three dual-polarization columns.

It should be clear that the concept of vertical beam splitting, using polarization diversity and pattern diversity can be applied equally to macro antennas or to small antennas. The vertical array of the resulting antenna can have any number of elements. As well, in a multi-band antenna, some arrays or bands may use vertical beam splitting while other arrays or bands in the same antenna may not use this vertical beam splitting concept. As an example, in a 12-port macro antenna that has two dual-polarization low band columns and 4 dual polarization mid-band columns, only the low band elements might use the vertical beam splitting concept. It should also be clear that the vertical beam splitting concept may be used to generate more than 2 beams depending on channel requirements.

As noted above, the vertical beam direction can be controlled remotely using remote electrical tilt (RET). FIGS. 20A and 20B show matrix architectures for VBD (Variable Beam Direction) Blass matrix in which beam directions can be controlled by adjusting phase shifters. In the architecture shown in FIG. 20A, only the top row has variable phase shifters. In this architecture, only the first beam will rotate. In the architecture shown in FIG. 20B, each row has variable phase shifters. In this architecture, each beam direction can be controlled independently.

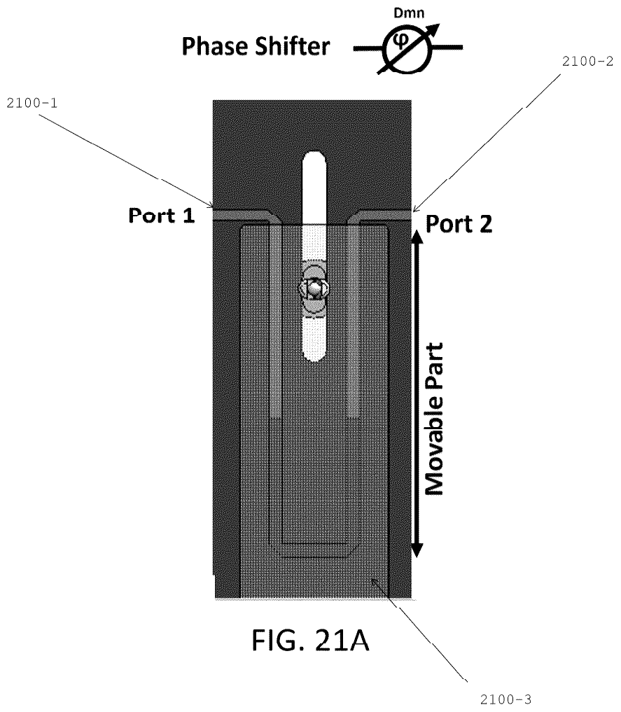

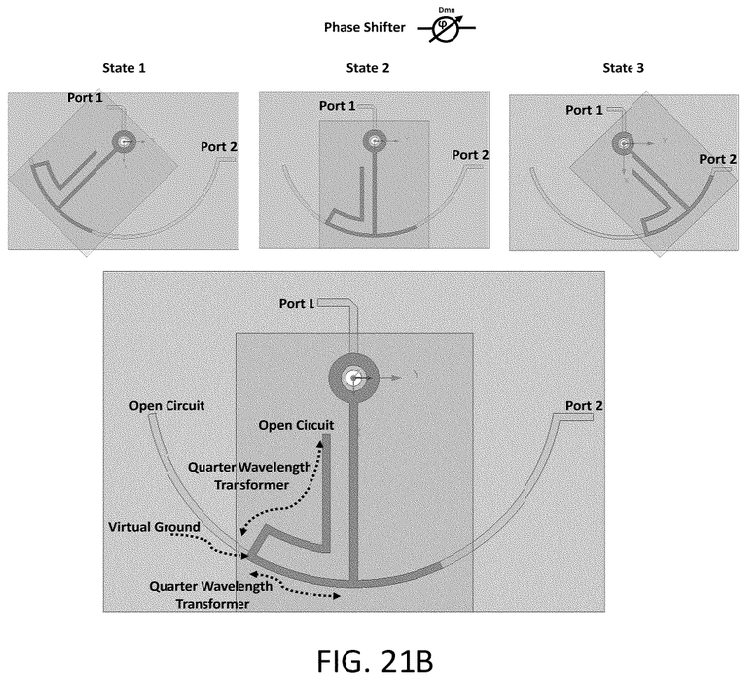

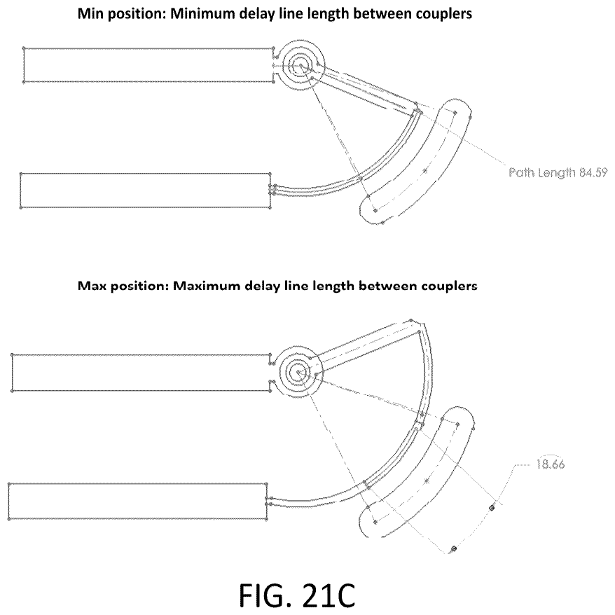

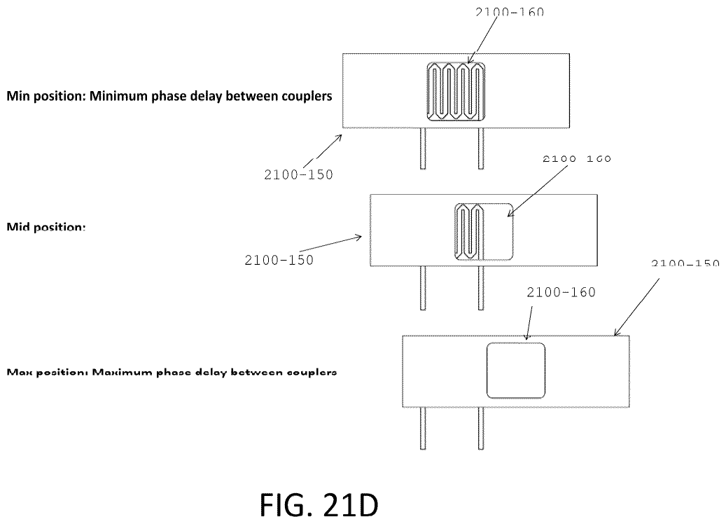

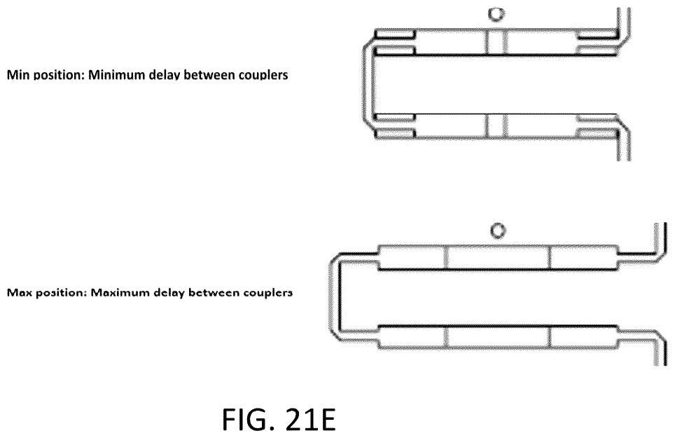

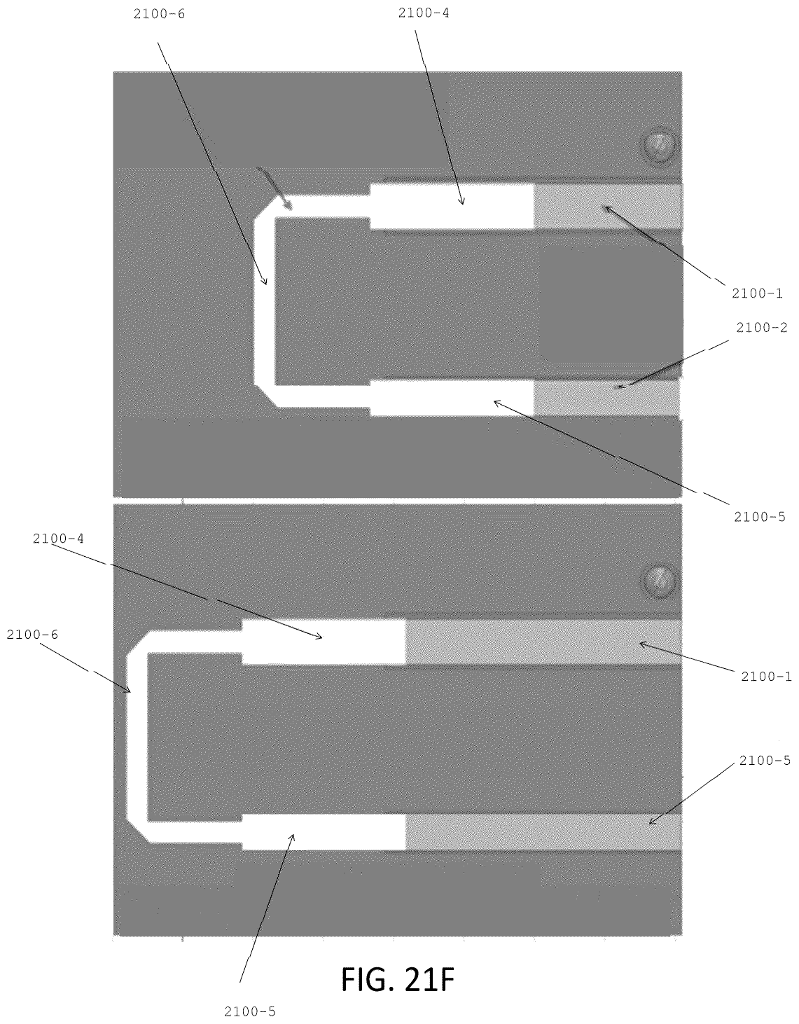

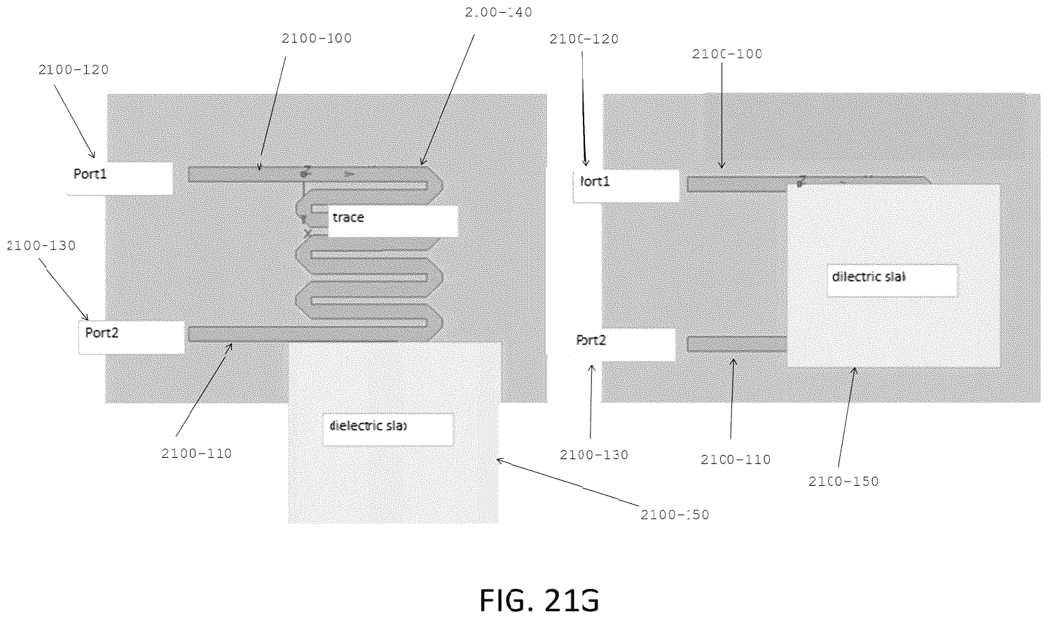

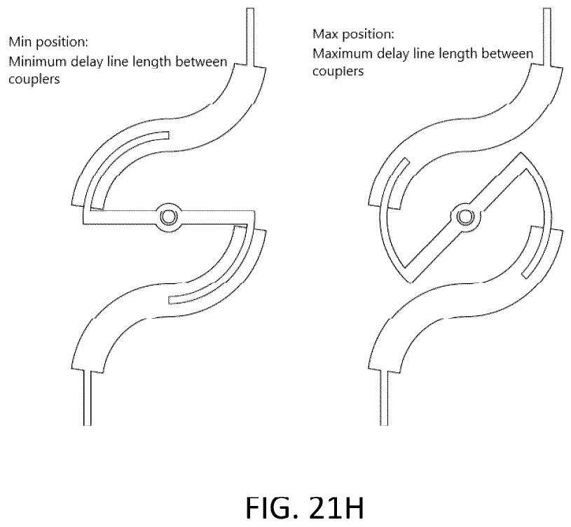

As would be clear to the person of skill in the art, phase shifters can be electromechanical phase shifters which are controlled using motors. FIGS. 21A, 21B, 21C, 21D, and 21H depict five possible variable phase shifter designs. FIG. 21A is a schematic diagram of a trombone-shaped phase shifter, which comprises a movable part that adjusts the phase shifter by linear movement. FIG. 21B is a schematic diagram of a rotary phase shifter. As shown in FIG. 21B, a rotating part rotates and changes the arc length to adjust the phase shifter, which can also be applied to azimuth. FIG. 21C is a rotary variable delay line phase shifter. FIG. 21D illustrates another example of a variable phase shifter, which utilizes a high-permittivity dielectric placed above the delay line to achieve a variable phase shift. It should, of course, be understood that any suitable variable phase shifter may be used in the present invention, and that FIGS. 21A, 21B, 21C, 21D, and 21H merely depict exemplary variable phase shifter structures.

Referring to FIG. 21A and FIG. 21F, illustrated is the trombone shaped variable phase shifter. FIG. 21A shows the front of the phase shifter while FIG. 21F shows two positions of the movable portion of the variable phase shifter. As can be seen, the phase shifter has two traces 2100-1, 2100-2 for coupling to two ports. A first port can be coupled to trace 2100-1 while a second port can be coupled to trace 2100-2. The phase shifter also has a bridge element 2100-3 with overlapping portions 2100-4, 2100-5 and a connecting portion 2100-6. As can be seen, overlapping portion 2100-4 overlaps trace 2100-1 while overlapping portion 2100-5 overlaps trace 2100-2. Connecting portion 2100-6 connects the overlapping portion 2100-4 to overlapping portion 2100-6. From FIG. 21F, the top image shows a first tilt position while the bottom image shows a second tilt position. The phase shifter operates by adjusting the electrical length/path between the two traces, thereby lengthening the electrical distance/path to be traveled by a signal passing between the two ports such that a variable phase delay between the ports is introduced. The phase shifter transitions from the two tilt positions by moving/sliding the movable portion. From FIG. 21A when the movable portion is slid in a direction that is towards the traces, then the phase shifter is moved towards the first tilt position. When the movable portion is slid in a direction away from the traces, then the phase shifter is moved towards the second tilt position. At both tilt positions, there is an electrical distance that a signal passing between the ports must traverse and this distance determines the amount of phase delay introduced. Changing the electrical distance is accomplished by adjusting the amount of overlap between the overlapping portions and the traces. As can be seen from FIG. 21F, the electrical distance is longer/larger at the second tilt position than at the first tilt position and, accordingly, a larger phase delay is introduced when the phase shifter is at the second tilt position. Thus, the greater the area of overlap between the overlapping portions and the traces, then the less the phase delay introduced. Similarly, the lesser the area of overlap (and hence the larger the electrical distance) then the greater the phase delay introduced.

It should be clear that, depending on the implementation of this design of a variable phase shifter, the amount of phase delay may be a continuum of values between the minimal phase delay (when at the first tilt position) and the maximum phase delay (when at the second tilt position). Alternatively, there may be a fixed number of phase delay values that the variable phase shifter can be set to. Such a fixed number would, of course, depend on the number of fixed tilt positions designed/implemented into the variable phase shifter. Thus, in the implementation illustrated in FIG. 21F, there are at least two fixed tilt positions for two phase delay values—a maximum phase delay (at the second tilt position with minimal overlap and maximum electrical length) and a minimum phase delay (at the first tilt position with maximum overlap and minimum electrical length). Extra fixed tilt positions between these two extremes can, of course, be implemented for extra fixed phase delay values.

Referring to FIG. 21B, it should be clear that this implementation of a variable phase shifter operates on the same principle as the variable phase shifter in FIG. 21A. It can be seen that, instead of a linear movement to increase/decrease the amount of overlap between an overlapping portion and a trace (to thereby increase/decrease the electrical path/length), the variable phase shifter in FIG. 21F uses a rotary motion. As can be seen from FIG. 21B, a first port is coupled to a trace that connects to a pivot point. The pivot point connects to an arm that is connected to an arcuate overlapping portion that overlaps a similarly arcuate trace, with this other trace being coupled to the second port. As can be seen, the structure in FIG. 21B is function specific—the transformers that form part of the arm is preferably quarter wavelength to thereby make the variable length of the phase shifter open. When a quarter wavelength transmission line is short on one side, it will open on the other side and vice versa. The first quarter wavelength at the middle converts the open circuit at the top of the arm to a virtual short circuit on the arc. This means that the left side of the arc will be in parallel with a short circuit. This will make the left side of the arc short circuit no matter what its length as the length changes by rotating the phase shifter arm. The second quarter wavelength converts the short circuit to an open circuit at the bottom center of rotating arm. This way, any part of the moving part (i.e., the arm) on the side will be always open.

From FIG. 21B, it can be seen that there are three possible positions—shown as state 1, state 2, and state 3 in FIG. 21B. States 1 and 3 are the extremes—state 1 has the longest electrical length between port 1 and port 2 while state 3 has the shortest electrical length between these two ports. State 2 has an intermediate electrical length between the two ports.

Referring to FIG. 21C, illustrated is a variant of the variable phase shifter that uses rotary motion. As can be seen, one trace is coupled to a pivot point and the pivot point attaches to an arm that leads to an arcuate overlapping portion. The overlapping portion overlaps an arcuate section of a second trace. By rotating the arm/overlapping portion between two extremes (the first extreme being pictured at the top image in FIG. 21C and the second extreme being pictured at the bottom image in FIG. 21C) then the phase delay introduced to a signal traveling between the two traces is adjusted. Of course, by adjusting the position of the arm/overlapping portion, any delay value between the maximum delay (at one extreme) and the minimum delay (at the other extreme) can be achieved.

It should be clear that, to implement the variable phase shifters illustrated in FIGS. 21A-21C, the traces are on a first PCB while the overlapping portion/movable portions are on another, second PCB. Of course, the second PCB is movable relative to the first PCB and this ability for relative motion allows for the transition between the tilt positions or for the positions between the extreme phase delay settings.

Referring to FIG. 21D, illustrated is another configuration for a variable phase shifter. As can be seen, a linear motion of a “cover” covers or overlaps different amounts of the trace between two ports. In this implementation, the cover is a high permittivity dielectric slab and, the amount of the trace overlapped or covered determines the phase delay between the ports coupled by the traces. From FIG. 21D, there are three settings for the phase delay—maximum phase delay, minimum phase delay, and a middle setting that provides a phase delay that is between the maximum and the minimum. To explain the concept behind this design, FIG. 21G is provided.

As can be seen from FIG. 21G, the left side illustration shows a first trace 2100-100 and a second trace 2100-110 with the first trace 2100-100 being coupled to a first port 2100-120 and the second trace 2100-110 being coupled to a second port 2100-130. Both the first and second traces 2100-100, 2100-110 are part of the elongated trace 2100-140. Thus, a signal travelling between the first port 2100-120 and the second port 2100-130 traverses this elongated trace 2100-140. However, a slab 2100-150 with a high dielectric constant can be used to overlap/overhand at least part of this elongated trace 2100-140. By doing so, this changes the propagation constant, and the effect is the same as extending the electrical path or trace length of the elongated trace. Thus, the configuration to the left of FIG. 21G has the minimal phase delay (with the dielectric slab not overhanging or overlapping any portion of the elongated trace) while the configuration to the right of FIG. 21G has the maximum phase delay as the dielectric slab overhangs or overlaps all of the elongated trace. Referring to FIG. 21D, it can thus be seen that the dielectric slab 2100-150 has a window 2100-160. When the window 2100-160 overlaps the elongated trace, then the dielectric slab 2100-150 does not overlap the trace and, accordingly, does not change the propagation constant (see FIG. 21D top image) and there is minimal phase delay for a signal traveling between the ports. When the dielectric slab 2100-150 overlaps the trace (see FIG. 21D, bottom image), this changes the propagation constant and thereby causes maximum phase delay for any signal traveling between the ports. Of course, when the window 2100-160 only overlaps some of the trace (see FIG. 21D, middle image), then this changes the propagation constant for some of the trace and thereby introduces some phase delay for the signal traveling between the ports.

Referring to FIG. 21E, illustrated is a variable phase shifter structure that can be incorporated into a suitable circuit. For this structure, the coupler traces serve as the necessary delay line within the variable phase shifter structure. A glance at FIG. 21E shows that the top image of the trombone-shaped phase shifter shows shorter traces than the bottom image. This longer/shorter trace is accomplished by a linear motion that is similar to the structure in FIG. 21A and FIG. 21F.

Referring to FIG. 21H, another structure for a variable phase shifter is illustrated. As can be seen, rotary motion of the structure about the center pivot point can extend/shorten the electrical length/distance between the ports. As can be seen, one port is at the top of the images while another port is at the bottom of the images. The left image shows a minimum phase delay setting between the ports while the right image shows a maximum phase delay setting between the ports.

It should be clear that the above discussed architectures/structures for implementing variable phase shifters can be integrated with the couplers' traces to enhance system efficiency and to minimize losses by reducing the delay line length between couplers. As has been seen, in this approach, the coupler traces themselves can serve as the necessary delay line within the variable phase shifter structure.

For even greater clarity, any of the above discussed variable phase shifter structures may be used in any of the MBFNs noted in this document. The variable phase shifter may be used between any two horizontally adjacent directional couplers or between any two vertically adjacent directional couplers. Similarly, variable phase shifters may be used in place of the phase shifters schematically illustrated in the various figures in this document.

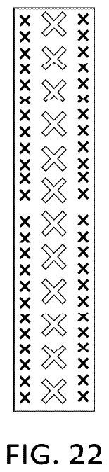

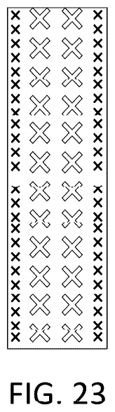

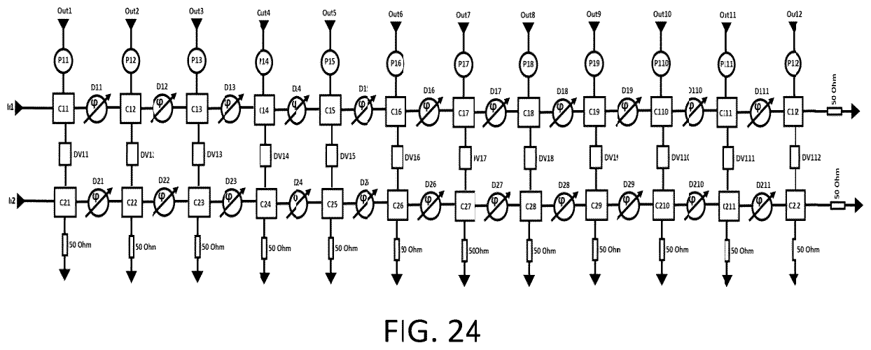

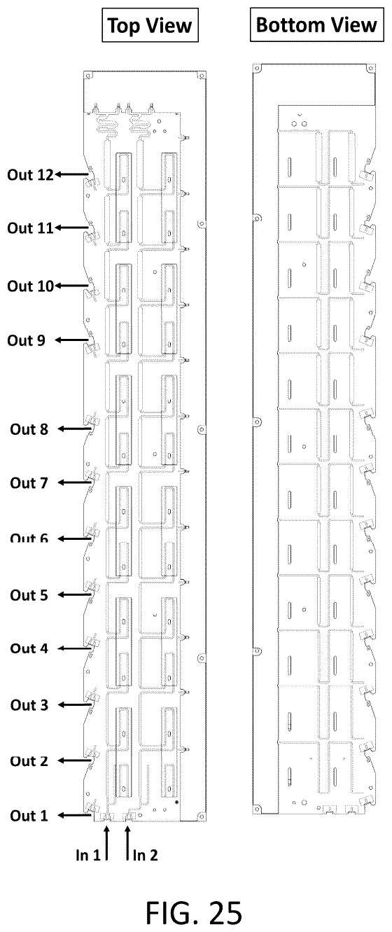

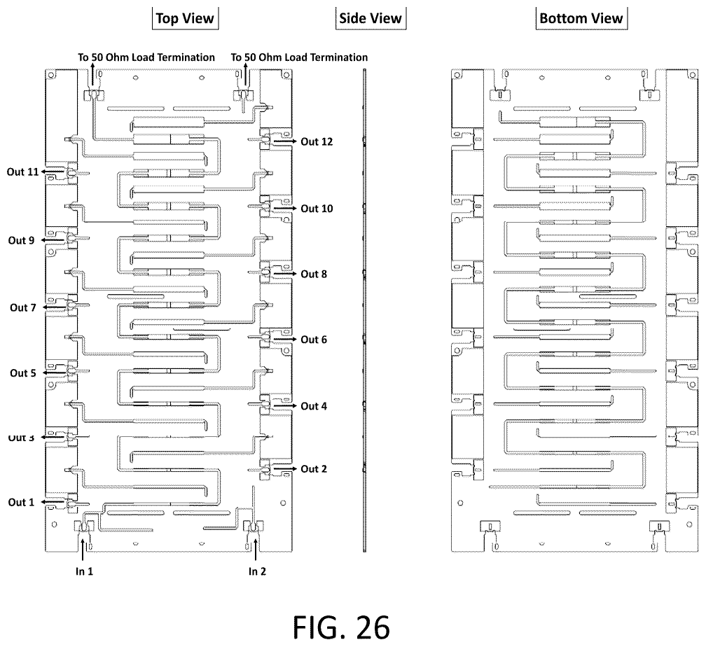

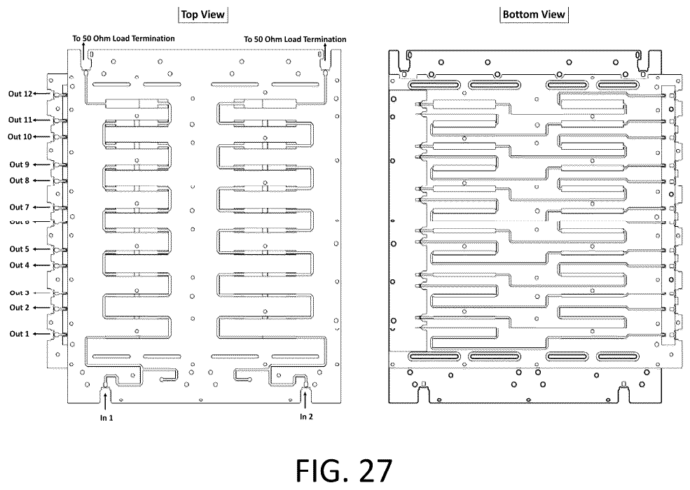

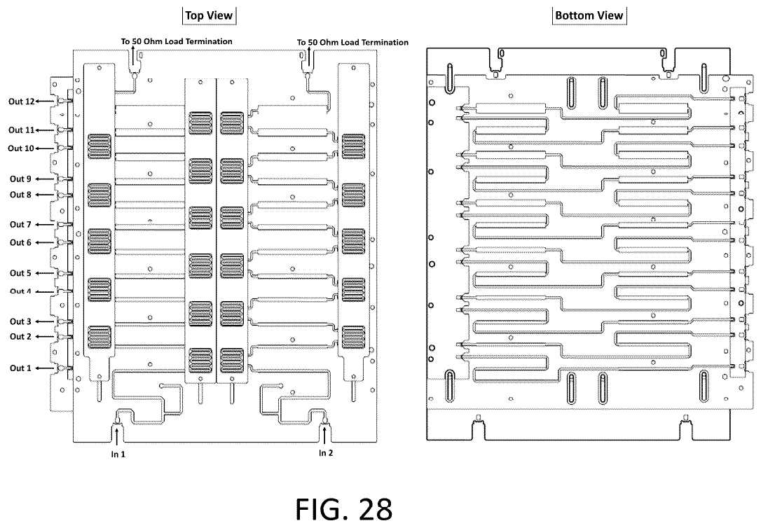

Referring to FIG. 22 and FIG. 23, illustrated are 8-port mid-band 65-degrees azimuth beamwidth antenna arrays. These antenna arrays are equipped with 4-ports in low-band (see FIGS. 22) and 8-ports in low-band (see FIG. 23). The low-band arrays both have beam splitting in elevation. Shown in FIG. 24 is a schematic diagram of a low-band matrix circuit. Different implementations of this matrix circuit in FIG. 24 are shown in FIG. 25, FIG. 26, FIG. 27, and FIG. 28. These different implementations use different variable phase shifter structures as will be explained below.

Referring to FIG. 25, as can be seen, all the outputs are on one side of the circuit board and the variable phase shifters between the directional couplers are shown as rectangles that cover directional coupler structures. In the illustrated embodiment, all the phase shifters are set to one of the two extreme settings (minimal and maximum phase delay settings). The phase shifter can sweep the beams continuously by linear movement of trombone-shaped phase shifter between the minimum phase delay setting and the maximum phase delay setting.

Referring to FIG. 26, shown is another embodiment of the matrix circuit schematically shown in FIG. 24. As can be seen, the outputs are on two of the sides of the circuit board. The variable phase shifters between the directional couplers use the structure shown in FIG. 21F and FIG. 21E. FIG. 26 shows those variable phase shifters as being in the minimal phase delay setting. For the variable phase shifters in the maximum phase delay setting, the variable phase shifters would have the appearance as shown in the bottom image of FIG. 21E. The phase shifters in the matrix circuit of FIG. 26 can sweep the beams continuously by linear movement of integrated trombone-shaped phase shifter between a minimum phase delay setting and a maximum phase delay setting.

Referring to FIG. 27, shown is yet another embodiment of the matrix circuit schematically shown in FIG. 24. The outputs for this embodiment are all on one side of the circuit board and the variable phase shifters between the directional couplers are, again, implemented using the structure shown in FIG. 21F and FIG. 21E. These variable phase shifters, for this embodiment, have two settings (much like in FIG. 26)—a maximum phase delay and a minimal phase delay (illustrated in FIG. 27). As with the embodiment in FIG. 26, the phase shifters are shown in the minimal phase delay setting. The phase shifters in the matrix circuit of FIG. 27 can sweep the beams continuously by linear movement of the integrated trombone-shaped phase shifters between a minimum phase delay setting and a maximum phase delay setting.

Referring to FIG. 28, illustrated is a further embodiment of the matrix circuit schematically shown in FIG. 24. For this implementation, the variable phase shifters between the directional couplers use the structure explained and illustrated in FIG. 21D and FIG. 21G. As can be seen from FIG. 28, the phase shifters illustrated are in the minimum phase delay setting. When in the maximum phase delay setting, the dielectric substrate would overlap all the various elongated traces for each of the directional couplers. A middle setting, where only some phase delay is introduced, is also possible. It should, however, be noted that these phase shifters can sweep the beams continuously by linear movement of the dielectric slabs between a minimum phase delay setting and a maximum phase delay setting

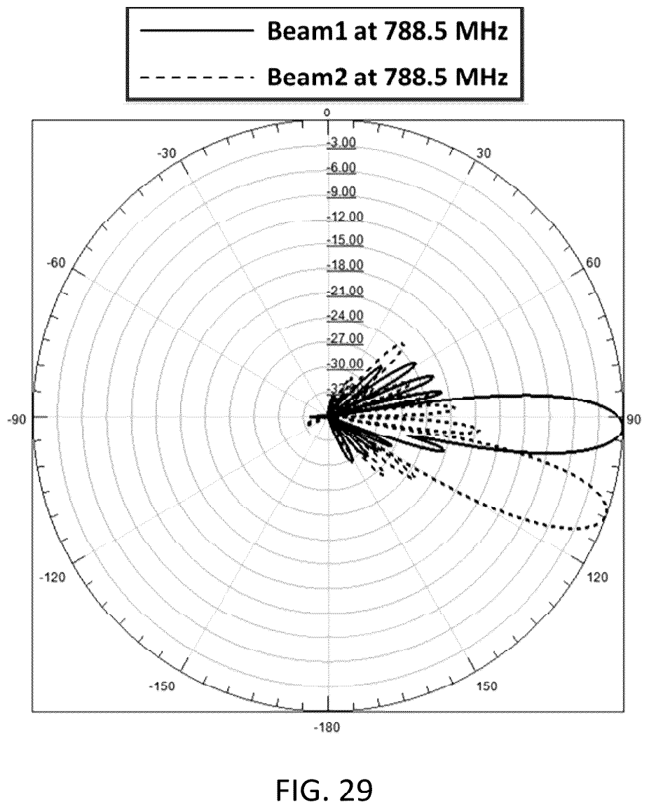

Referring to FIG. 29, illustrated is an example of two beams being produced in elevation using the low-band arrays shown in FIG. 22 and FIG. 23.

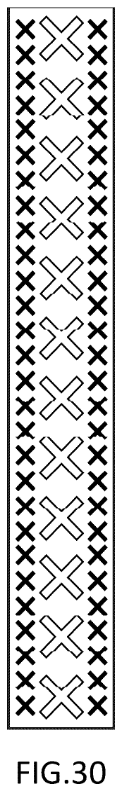

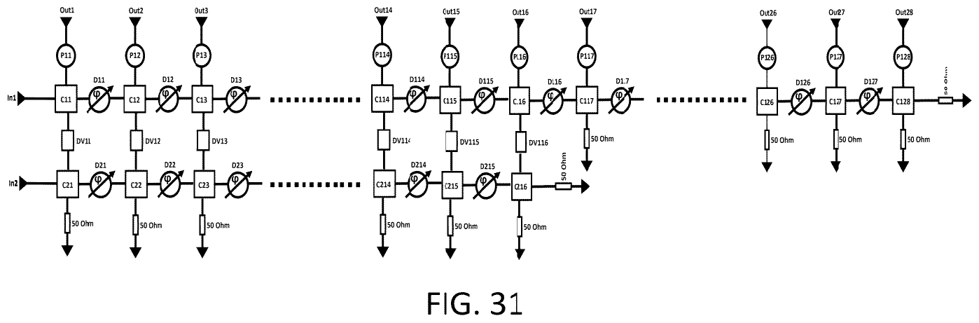

Referring to FIG. 30, illustrated is 65-degrees azimuth beamwidth antenna array which has 8-ports for mid-band and 4-ports for low-band. Both mid-band and low-band arrays have beam splitting in elevation. The low-band MBFN circuit is the same as that illustrated in FIG. 24.

Referring to FIG. 31, illustrated is a schematic diagram for a mid-band beamforming matrix circuit. This mid-band beamformer is designed to produce two beams with different desired elevations and beamwidth. For clarity, this means that two beams are produced at different elevations and with different beamwidths. For clarity, FIG. 31 shows an MBFN with two rows of directional couplers. Each directional coupler on the top row (28 directional couplers) is coupled to adjacent directional couplers by way of variable phase shifters and each of these 28 directional couplers is coupled to an antenna output by way of a fixed phase shifter. The bottom (or second row) of directional couplers only has 16 directional couplers and, again, each directional coupler is coupler to adjacent directional couplers by way of adjustable phase shifters. For each row, the last directional coupler in the row is terminated with a matching load. As well each of the bottom row directional couplers is similarly terminated with a matching load. The last 12 directional couplers in the top row that is not coupled to a bottom row coupler is similarly terminated with a matching load.

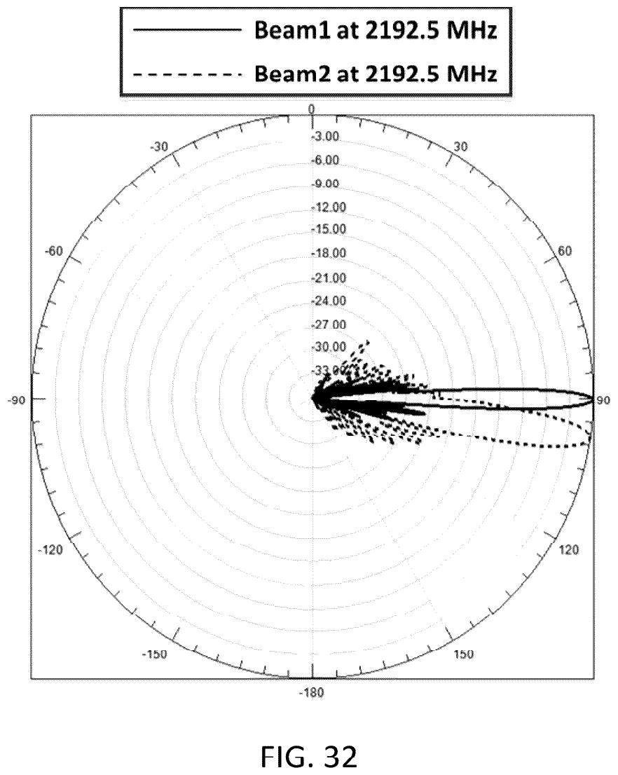

Referring to FIG. 32, the diagram illustrates an example of two beams being produced by the mid-band array illustrated in FIG. 31.

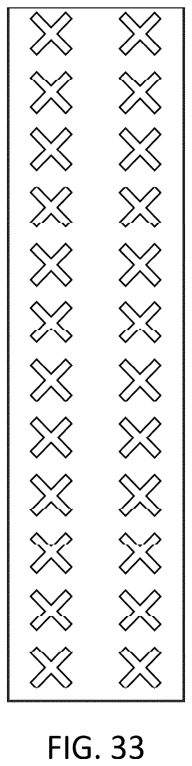

The low-band elevation beam splitting antenna arrays shown in FIG. 22 and in FIG. 23 can be implemented using the array shown in FIG. 33 and, in one implementation, can also have a 65-degrees azimuth beamwidth.

A person understanding this invention may now conceive of alternative structures and embodiments or variations of the above all of which are intended to fall within the scope of the invention as defined in the claims that follow.

What is claimed is:

1. An antenna system comprising:
multibeam forming network circuitry for receiving at least one input signal;
an antenna array comprising at least two antenna elements, said antenna array receiving an output of said circuitry;
wherein
said system produces at least two output beams from said array such that said at least two output beams are vertically adjacent each other.

2. The system according to claim 1, wherein said multibeam forming network circuitry comprises one or more of:
a Butler matrix;
a Rotman lens;
a Nolen matrix;
a Blass matrix;
a modified Blass matrix;
a modified Nolen matrix; and
a modified Butler matrix.

3. The system according to claim 1, wherein said multibeam forming network circuitry comprises a matrix circuit, said matrix circuit comprising a plurality of directional couplers and delay lines, said matrix circuit being coupled between a plurality of loads and said antenna array;
wherein
each row of said matrix circuit comprises a plurality of directional couplers coupled in series row-wise, with each row-wise pair of directional couplers being joined by at least one delay line,
each column of said matrix circuit comprises a plurality of directional couplers coupled in series column-wise,
a bottom row of said matrix circuit is coupled to a plurality of matching loads such that each directional coupler of said bottom row is coupled column-wise between a matching load of said plurality of matching loads and a directional coupler of an immediately preceding row of said matrix circuit,
said each row of said matrix circuit provides a distinct signal beam having a unique elevation within a predetermined azimuth range, such that at least three distinct signal beams are provided by said antenna array, said at least three distinct signal beams comprising at least one negative-extreme-azimuth beam corresponding to a negative extreme of said azimuth range, a center azimuth beam corresponding to a center of said azimuth range, and a positive-extreme-azimuth beam corresponding to a positive extreme of said azimuth range, and
said circuit is used to implement a method comprising providing said center azimuth beam with said bottom row of said matrix circuit.

4. The system according to claim 1, wherein said multibeam forming network circuitry comprises a matrix circuit, said matrix circuit comprising a plurality of directional couplers and delay lines, said matrix circuit being coupled between a plurality of loads and said antenna array;
wherein
each row of said matrix circuit comprises a plurality of directional couplers coupled in series row-wise, with each row-wise pair of directional couplers being joined by at least one delay line,
each column of said matrix circuit comprises a plurality of directional couplers coupled in series column-wise,
a bottom row of said matrix circuit is coupled to a plurality of matching loads such that each directional coupler of said bottom row is coupled column-wise between a matching load of said plurality of matching loads and a directional coupler of an immediately preceding row of said matrix circuit,
said each row of said matrix circuit provides a distinct signal beam having a unique azimuth within a predetermined elevation range, such that at least three distinct signal beams are provided by said antenna array, said at least three distinct signal beams comprising at least one negative-extreme-elevation beam corresponding to a negative extreme of said elevation range, a center elevation beam corresponding to a center of said elevation range, and a positive-extreme-elevation beam corresponding to a positive extreme of said elevation range, and
said circuit is used to implement a method comprising providing said center elevation beam with said bottom row of said matrix circuit.

5. The system according to claim 4, wherein phase compensation is applied to each of said plurality of directional couplers.

6. The system according to claim 3, wherein phase compensation is applied to each of said plurality of directional couplers.

7. The system according to claim 2, wherein said multibeam forming network circuitry comprises a matrix circuit, said matrix circuit being for coupling a plurality of input signal beams to said antenna array, said matrix circuit comprising:
a matrix of directional couplers, horizontal phase delay lines, and vertical circuit element lines;
wherein said matrix is configured to form
a plurality of rows of circuit elements, each row of circuit elements comprising directional couplers and horizontal circuit element, each row receiving an input signal beam and each row comprising directional couplers being coupled to at least one other directional coupler by a horizontal delay line; and
a plurality of columns of circuit elements, each column of circuit elements comprising directional couplers and vertical circuit element lines, each column of circuit elements being coupled between an output antenna in said antenna array and a load;
wherein said matrix circuit is for forming multiple output beams based on said input signal beams.

8. The system according to claim 7, wherein an input signal beam having a lowest absolute value elevation angle of said plurality of input signal beams is received by a specific row of said matrix circuit, said specific row being most adjacent to loads to which said matrix circuit is coupled.

9. The system according to claim 7, wherein an input signal beam having a lowest absolute value azimuth angle of said plurality of input signal beams is received by a specific row of said matrix circuit, said specific row being most adjacent to loads to which said matrix circuit is coupled.

10. The system according to claim 7, wherein said vertical circuit element lines are implemented as one or more of:
phase shifters;
adjustable phase shifters; and
vertical phase delay lines.

11. The system according to claim 7, wherein said horizontal circuit element lines are implemented as one or more of:
phase shifters;
horizontal phase delay lines; and
adjustable phase shifters.

12. The system according to claim 1, wherein each of said at least two antenna elements in said antenna array is coupled to said circuitry by way of a phase shifter.

13. The system according to claim 1, wherein said system further produces at least one further output beam, said at least one further output beam being horizontally adjacent to at least one of said output beams.

14. The system according to claim 1, wherein, of said at least two output beams, at least one of said at least two output beams has a beamwidth that is different from a beamwidth of another of said least two output beams.

15. The system according to claim 11, wherein each of said adjustable phase shifters has an electromechanically adjustable phase shift, at least one of said adjustable phase shifters comprising:
a first trace for coupling to a first port;
a second trace for coupling to a second port;
bridge element that couples said first trace to said second trace;
wherein
said bridge element overlays atop both said first trace and said second trace such that said bridge element provides an electrical path for signals traveling between said first port and said second port;
said bridge element is mechanically movable between at least two positions;
moving said bridge element from one position to another position of said at least two positions changes a length of said electrical path between said first port and said second port.

16. The system according to claim 15, wherein said at least two positions comprises any one of:
a first fixed position and a second fixed position;
a plurality of fixed positions;
wherein each fixed position is a fixed setting for a specific length of electrical path between said first port and said second port.

17. The system according to claim 1, wherein said antenna system has a performance that is equivalent to a performance of another antenna system that has a larger antenna array in size.

18. The system according to claim 1, wherein said antenna system has a performance that is equivalent to a performance of another antenna system that has a larger number of antenna columns than said antenna system.

19. The system according to claim 1, wherein said at least two output beams provide pattern diversity to improve a wireless link implemented through said antenna system.

20. The system according to claim 7, wherein at least one input signal beam is coupled to produce at least one output beam using all of said antennas in said antenna array.

21. The system according to claim 7, wherein at least one input signal beam is coupled to produce at least one output beam using a subset of said antennas in said antenna array.
